(19) United States
(12) Patent Application Publication
(10) Pub. No.: US 2012/0166933 A1
(43) Pub. Date: Jun. 28, 2012

(54) VERIFYING PAGE LAYOUT AUTOMATICALLY

(75) Inventors: Jun Tao Cui, Shanghai (CN); Gu Yi He, Shanghai (CN); Wei Huang, Shanghai (CN); Xiao Wen Zhu, Shanghai (CN)

(73) Assignee: International Business Machines Corporation, Armonk, NY (US)

(21) Appl. No.: 13/292,317

(22) Filed: Nov. 9, 2011

(30) Foreign Application Priority Data
Dec. 23, 2010 (CN) 201010612374.0

(51) Int. Cl. G06F 17/00

(52) U.S. Cl. 715/234

(57) ABSTRACT

Verifying a page layout automatically, including reading page layout rules and parsing the page layout rules. A list of one or more of the page layout rules is generated based on the parsing. Page layout information is collected and verification is performed to verify that the page layout information conforms to the one or more page layout rules in the list.

### PRIORITY

The present application claims priority to Chinese Patent Application No. 201010612374.0, filed on Dec. 23, 2010, and all the benefits accruing therefrom under 35 U.S.C. §119, the contents of which are herein incorporated by reference in its entirety.

### BACKGROUND

The present invention relates to data processing, and more particularly, to a method for verifying a page layout.

A page, such as a webpage, displayed in a browser is an important and popular user interface. However, because of the flexibility of a page layout and the incompatibility between various browsers, it is difficult to verify the layout of a page automatically. In most cases, a tester has to visually inspect the page to ensure that the page layout is displayed as expected.

Existing methods in the art are mainly used to verify the content of a page as opposed to the layout of a page. One example of a content verification method is a document object model (DOM) based verification method. The DOM based verification method checks whether a DOM node matches a given criteria, such as verifying the text content of the node against an expected text value. If there is a match, then the result of the verification is successful. Thus, the DOM based verification method performs page layout verification. For example, a page will pass verification as long as a certain node complies with the matched text content. Another example of a method for page data verification is an image based verification method. The image based verification method compares a current page with a previously stored image to determine whether they match. Since the image based verification method is sensitive to the image itself, its implementation is complicated and the result of verification is inflexible.

### SUMMARY

According to exemplary embodiments, a method, system and computer program product for verifying a page layout automatically. The verifying includes reading page layout rules and parsing the page layout rules. A list of one or more of the page layout rules is generated based on the parsing. Page layout information is collected and verification is performed to verify that the page layout information conforms to the one or more page layout rules in the list.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing, and other features and advantages of the invention are apparent from the following detailed description taken in conjunction with the accompanying drawings in which:

FIG. 1 depicts a process flow for verifying page layout according to an embodiment;

FIG. 2A depicts an example of a page;

FIG. 2B depicts an example representation of the page corresponding to FIG. 2A displayed in a browser; and

FIG. 3 depicts a schematic diagram of a system for verifying page layout according to an embodiment.

### DETAILED DESCRIPTION

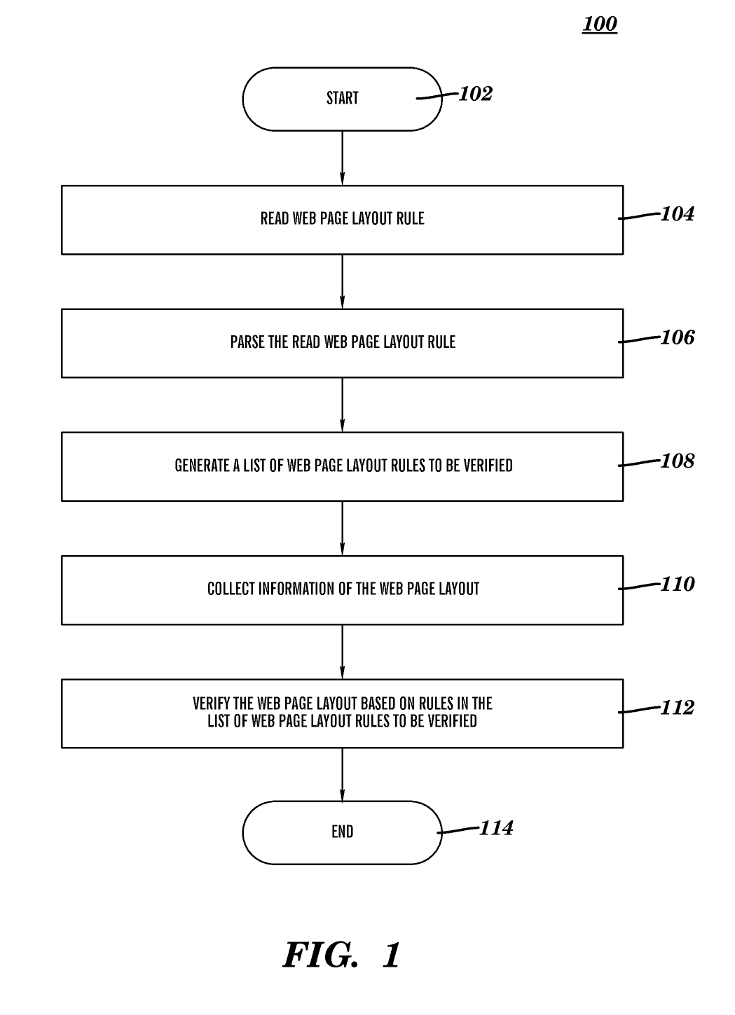

FIG. 1 depicts a process flow 100 that may be implemented in an embodiment. The process flow 100 starts at block 102. At block 104, page layout rules are read. The page layout rule is specified during design time for a page that is to be designed by a developer, and is used to test the correctness of the page layout of the page at runtime. A page is a combination of text and/or images displayed in a web browser. In an embodiment, the page may be a source page, such as a hypertext markup language (HTML) source page. In an embodiment, one or more pages are transmitted over the Internet from a webserver to a browser executing on a client computer system. In an additional embodiment, a page is transmitted over a local network (e.g. an Intranet) from a web server to a web browser executing on a client computer. In other embodiments, one or more pages are loaded to a browser from a file on the local client computer, or over a network from, for example, a file server. In an embodiment, the page layout rule includes independent rules and relative rules. The independent rules contain the properties of a page element itself, and the relative rules contain relationships among page elements. The page element may be a widget, a document object model (DOM), or a combination of the two. The independent rules define the area, the width, and/or the height of a page element, its position in the page, etc., and the relative rules define relationships among respective page elements, such as, distance between two widgets, ratio of their sizes, etc.

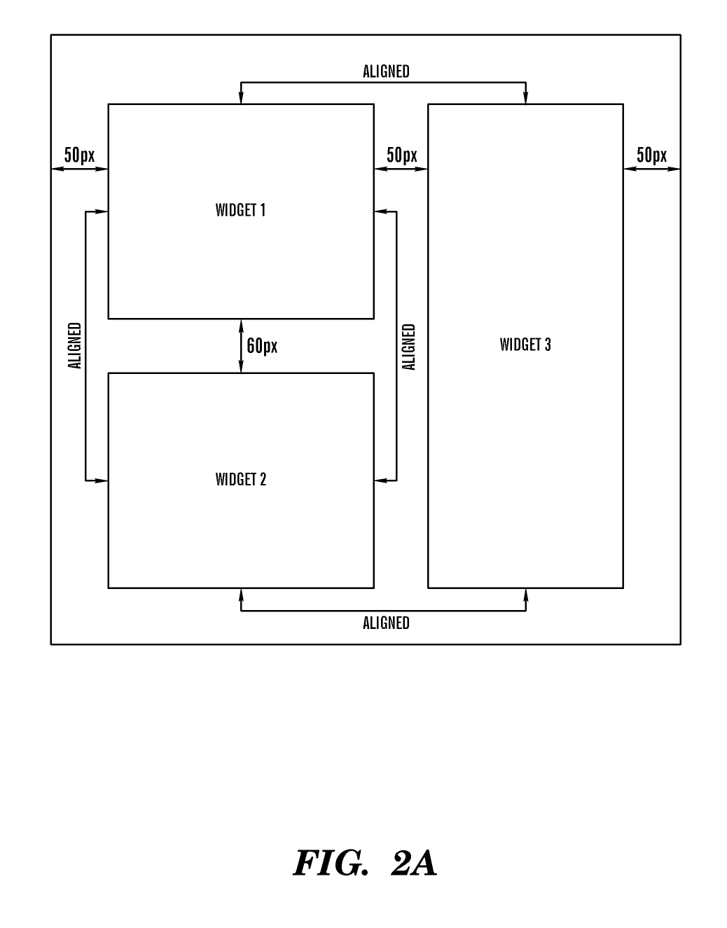

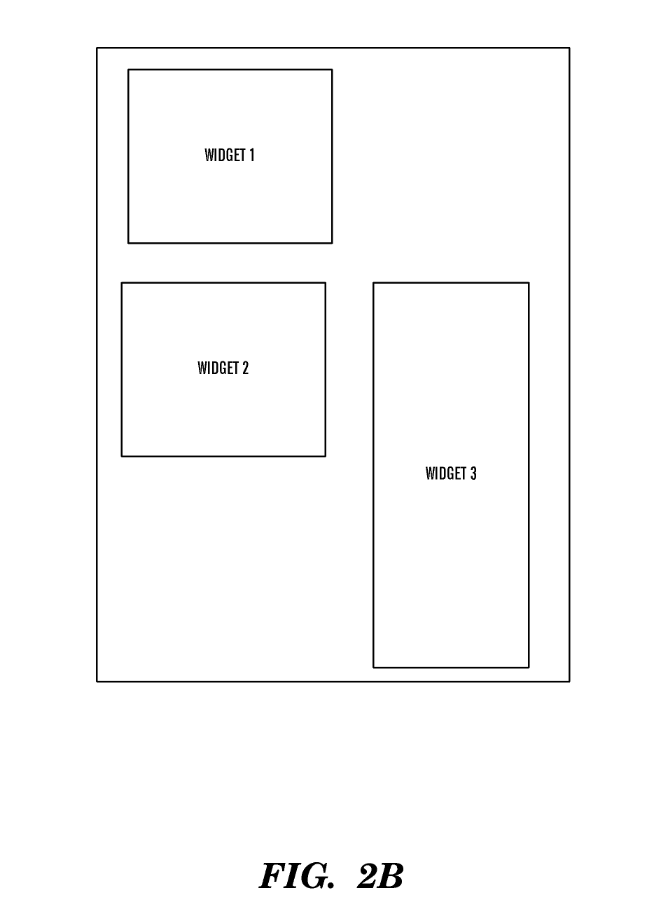

An example of a page layout rule will be illustratively described by using a widget as a page element. The example given below corresponds to page layout rule shown in FIG. 2A.

/* Layout Rules for MyTest.html */
/* Individual Rules */
Widget_1 {

width: 400px (10px);
page-position-left: 50px;

}
Widget_2 {

height: 300px (5px);

}
Widget_3 {

page-position-top: 70px;
page-position-right: 50px;

}
/* Relative Rules */
Widget_1 && Widget_2 {

position-difference-left: 0;
position-difference-right: 0;
vertical-margin: 60px (5px, 10px);
vertical-order: 1, 2;

}
Widget_1 && Widget_3 {

position-difference-top: 0;
horizontal-margin: 50px;

}
Widget_2 && Widget_3 {

position-difference-bottom: 0;

}

In the example given above, the page layout rules include properties of Widget 1, Widget 2 and Widget 3 themselves, i.e., independent rules, and the relationships between Widget 1, Widget 2 and Widget 3, i.e., the relative rules. Taking Widget 1 for example, the independent rules indicate that the width of Widget 1 is 400 pixels (px) and its error is within a range of 10 px. The relative rules indicate that Widget 1 is aligned with Widget 2 on its left and right sides, and that their distance is 60 px in a vertical direction with an error that is within a range of −5 px to +10 px, and that the order of the widgets is Widget 1 before Widget 2 in the vertical direction. The relative rules also indicate that Widget 1 is aligned with Widget 3 on their top sides, and that their distance apart is 50 px in the horizontal direction.

Table 1 shows some common properties of page elements. In the table, an example of properties of page elements and page layout rules is illustratively described. One of ordinary skill in the art will understand that the below description is merely for purpose of clarity, and that any other properties, or methods for defining properties, may be employed to define properties of page element and page layout rules in other embodiments. The example presented herein should not be construed as limiting.

TABLE 1
Properties of page elements in an embodiment

| Property name | Description | Example |
|---|---|---|
| page-position- | position of a page | widget-id1 { |
| (left/right/ | element relative | page-position-left: 10px (10%); |
| top/bottom) | to page | } |
| window- | position of a page | widget-id1 { |
| position- | element in the | window-position-left: 5px; |
| (left/right/ | browser window | } |
| top/bottom) | | |
| relative- | relative position | widget-id1 { |
| position- | of a page element | relative-position-left: 10px |
| (left/right/ | to another page | (1px, 2px); |
| top/bottom) | element | } |
| height | height of a page | widget-id1 { |
| | element | height: 200px (1%) |
| | | } |
| width | width of a page | widget-id1 { |
| | element | width: 200px (1%) |
| | | } |
| horizontal- | positional order of | widget-id1 && widget-id2 { |
| order | page elements in | horizontal-order: 2, 1; |
| | the horizontal | } |
| | direction | |
| vertical-order | positional order of | widget-id1 && widget-id2 { |
| | page elements in | vertical-order: 1, 2, 1; |
| | the vertical | } |
| | direction | |
| position- | positional | widget-id1 && widget-id2 { |
| difference- | relationships | position-difference-left: 10px; |
| (left/right/ | among boundaries | } |
| top/bottom) | of relevant page | |
| | elements | |

Returning to FIG. 1, at block 106, the page layout rules that were read are parsed. After a page layout rule is read, such as at block 104, the read page layout rule needs to be parsed in order to acquire a corresponding identifier of the page element from the page layout rules and the rules corresponding to the other page elements. In an embodiment, using the above page layout rules corresponding to FIG. 2, by parsing the rules, the page elements (i.e. Widget 1, Widget 2 and Widget 3) contained in the page of FIG. 2A and the rules corresponding to these page elements are acquired. These rules include the rules corresponding to the properties of Widget 1, Widget 2 and Widget 3 themselves, i.e., the independent rules, and also includes relationships between Widget 1, Widget 2 and Widget 3, i.e., the relative rules.

Processing then continues at block 108, where a list of page layout rules that are to be used for page verification is generated. A series of rules that are identified by a computer are generated by parsing the rules that were read, and a list of page layout rules to be verified is generated according to these rules. Using the above page layout rules for example, the list of page layout rules to be verified may include independent rules, such as properties of Widget 1 itself, and/or relative rules, such as the relationship between Widget 1 and Widget 2. All of these rules form the list of page layout rules to be used for verification of the page. According to the above page layout rules corresponding to FIG. 2A for example, the generated list of page layout rules to be verified is:

Widget_1:
{

width: 400px (10px);
page-position-left: 50px;

}
Widget_1 && Widget_2
{

position-difference-left: 0;
position-difference-right: 0;
vertical-margin: 60px (5px, 10px);
vertical-order: 1, 2;

}
Widget_1 && Widget_3 {

position-difference-top: 0;
horizontal-margin: 50px;

}
Widget_2:
{

height: 300px (5px);

}
Widget_2 && Widget_3
{

position-difference-bottom: 0;

}
Widget_3:
{

page-position-top: 70px;
page-position-right: 50px;

}

Once the rules are identified, at block 110, information about the layout of the page is collected. In an embodiment, the information about the page layout is collected in units of page elements. The page elements may be one or more widgets or a DOM, or a combination thereof. The information of page layout may include properties of the page elements, such as area, the width and the height of a page element, or its position on a page, etc. Corresponding properties of a page element may be acquired by parsing a DOM tree of the page displayed in a browser, thereby acquiring the information about the page layout. FIG. 2B depicts the same page elements of FIG. 2A but using a different layout. The following properties of the page element may be acquired by parsing a DOM tree of a page corresponding to FIG. 2B.

Widget_1:
{

Window-position: 70px, 300px, 400px, 50px;
page-position: 70px, 300px, 900px, 50px;
height: 300px;
width: 400px;
max-z-index: 0;
min-z-index: 0;

}
Widget_2:
{

Window-position: 40px, 330px, 30px, 20px;
page-position: 40px, 330px, 550px, 20px;
height: 300px;
width: 400px;
max-z-index: 0;
min-z-index: 0;

}
Widget_3:
{

Window-position: 420px, 50px, −400px, 500px;
page-position: 420px, 50px, 0px, 500px;
height: 850px;
width: 150px;
max-z-index: 0;
min-z-index: 0;

}

At block 112, the page layout of the page in FIG. 2B is verified based on rules in the list of page layout rules. First, independent rules of respective page elements are verified by using the acquired properties of the page elements. For example, for the Widget 1 in the above example, its independent rules include:

width: 400 px (10 px);

page-position-left: 50 px;

The width of Widget 1 in the acquired properties of the page element of FIG. 2B is 400 px, thus the width related rule passes verification. The distance from Widget 1 to left edge of the page in the acquired properties of page element is 70 px. The page position rule, however, requires that the page position be 50 px from the left. Therefore the distance of Widget 1 does not comply with 50 px in the page layout rules, and it cannot pass verification. In an embodiment, the following content will appear in a report of verification result:

“Widget 1: window-position-left: 50 px, Actual: 70 px; Result: Fail”

In addition, the relative rules for Widget 1 in the above example have relative rules which include:

Widget_1 && Widget_2
{

position-difference-left: 0;
position-difference-right: 0;
vertical-margin: 60px (5px, 10px);
vertical-order: 1, 2;

}

Therefore, the distance from Widget 1 to the left edge of the page in the acquired properties of page element is 70 px, the distance from Widget 2 to the left edge of the page is 40 px, thus the distance between the left edges of Widget 1 and Widget 2 is 30 px, which does not comply with the alignment requirement of their left edges as defined in the relative rule (i.e., 0 px), thus it does not pass verification. Therefore, the following content will appear in the report of verification result:

“Widget 1 && Widget 2: position-difference-left: 0 px, Actual: −30 px; Result: Fail”

Processing then ends at block 114.

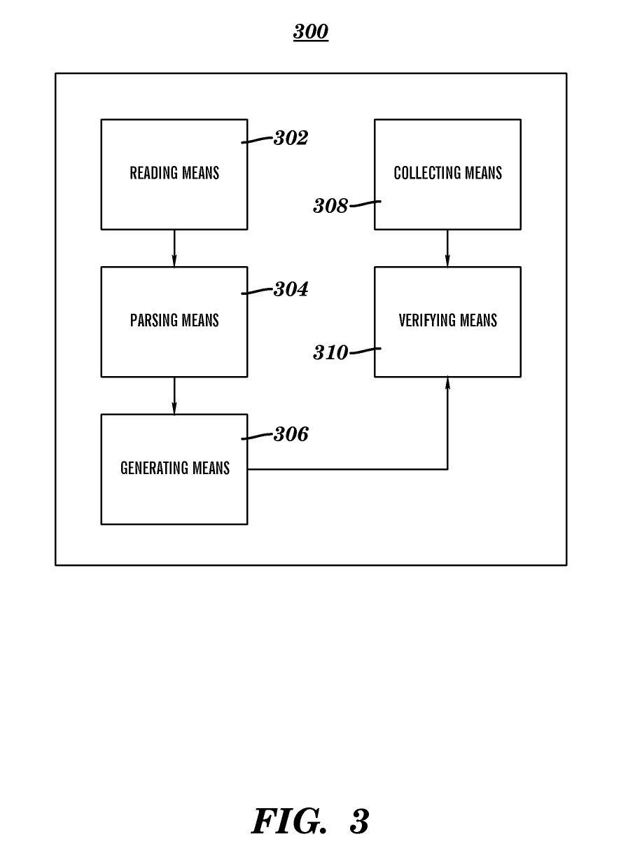

FIG. 3 depicts a schematic diagram of a system 300 for verifying page layout according to an embodiment. The system includes a reading means 302 configured to read page layout rules; a parsing means 304 configured to parse the read page layout rules; a generating means 306 configured to generate a list of page layout rules to be verified; a collecting means 308 configured to collect information about the page layout; and a verifying means 310 configured to verify the page layout based on rules in the list about the page layout rules that are to be used for verification.

According to an embodiment, the page layout rules of the system 300 include independent rules and relative rules, in which the independent rules include properties of the page elements, and the relative rules include relationships among page elements. The collecting means 308 collects information about the page layout in units of page elements, where the page elements are widgets or DOM nodes, and the collected information about the page layout includes properties of the page element.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for verifying a page layout automatically, the method comprising:
reading page layout rules;
parsing, on a processor, the page layout rules;
generating, on the processor, a list of one or more of the page layout rules to be verified, the generating responsive to the parsing;
collecting page layout information; and
verifying that the page layout information conforms to the one or more page layout rules in the list.

2. The method according to claim 1, wherein the page layout rules include at least one independent rule and at least one relative rule, wherein the independent rule includes a rule related to properties of a page element, and the relative rule includes a rule related to a relationship among at least two page elements.

3. The method according to claim 1, wherein the page layout rules are predefined.

4. The method according to claim 1, wherein the page layout information is collected as units of one or more page elements.

5. The method according to claim 4, wherein each of the one or more page elements is a widget or a document object model (DOM) node.

6. The method according to claim 4, wherein the page layout information includes one or more properties of the one or more page elements.

7. The method according to claim 1, wherein at least one of the page layout rules specifies an acceptable error range.

8. A system for verifying a page layout automatically, the system comprising:
a processor configured for:
reading page layout rules;
parsing the page layout rules;
generating a list of one or more of the pages layout rules to be verified, the generating responsive to the parsing;
collecting page layout information; and
verifying that the page layout information conforms to the one or more page layout rules in the list.

9. The system according to claim 8, wherein the one or more page layout rules include at least one independent rule and at least one relative rule, wherein the independent rule includes a rule related to properties of a page element, and the relative rule includes a rule related to a relationship among at least two page elements.

10. The system according to claim 8, wherein the page layout rules are predefined.

11. The system according to claim 8, wherein the page layout information is collected as units of one or more page elements.

12. The system according to claim 11, wherein each of the one or more page elements is a widget or a document object model (DOM) node.

13. The system according to claim 11, wherein the page layout information includes one or more properties of the one or more page elements.

14. The system according to claim 8, wherein at least one of the page layout rules specifies an acceptable error range.

15. A computer program product for verifying a page layout automatically, the computer program product comprising:
a computer readable storage medium having computer readable program code embodied therewith, the computer readable program code comprising:
computer readable program code configured for:
reading page layout rules;
parsing the page layout rules;
generating a list of one or more of the page layout rules to be verified, the generating responsive to the parsing;
collecting page layout information; and
verifying that the page layout conforms to the one or more page layout rules in the list.

16. The computer program product according to claim 15, wherein the page layout rules include at least one independent rule and at least one relative rule, wherein the independent rule includes a rule related to properties of a page element, and the relative rule includes a rule related to a relationship among at least two page elements.

17. The computer program product according to claim 15, wherein the page layout rules are predefined.

18. The computer program product according to claim 15, wherein the page layout information is collected as units of one or more page elements.

19. The computer program product according to claim 18, wherein each of the one or more page elements is a document object model (DOM) node or a widget.

20. The computer program product according to claim 18, wherein the page layout information includes one or more properties of the one or more page elements.
